(19) United States
(12) Patent Application Publication
(10) Pub. No.: US 2015/0184941 A1
(43) Pub. Date: Jul. 2, 2015

(54) METHOD FOR PRODUCING CARBON FIBER BUNDLE AND HEATING FURNACE FOR CARBON FIBER PRECURSOR FIBER BUNDLE

(71) Applicant: Mitsubishi Rayon Co., Ltd., Chiyoda-ku, Tokyo (JP)

(72) Inventors: Risa Arai, Toyohashi-shi (JP); Satoshi Kaji, Otake-shi (JP); Atsushi Kawamura, Otake-shi (JP); Hiroyuki Nishi, Otake-shi (JP); Takafumi Tanaka, Toyohashi-shi (JP); Masashi Shimahara, Toyohashi-shi (JP)

(73) Assignee: Mitsubishi Rayon Co., Ltd., Chiyoda-ku, Tokyo (JP)

(21) Appl. No.: 14/412,346

(22) PCT Filed: Jun. 28, 2013
(86) PCT No.: PCT/JP2013/067858

§ 371 Date: Dec. 31, 2014

(30) Foreign Application Priority Data
Jul. 2, 2012 (JP) 2012-148807

(51) Int. Cl. F27D 7/06; D01F 9/12; F27D 7/04

(52) U.S. Cl. CPC F27D 7/06; F27D 7/04; D01F 9/12; F27D 2007/045; F27D 2007/063

(57) ABSTRACT

The present invention relates to a heating furnace suitable for a step in which a precursor fiber bundle is flameproofed. The heating furnace is provided with a hot air introduction duct disposed in a horizontal space and a heat treating chamber, and in the hot air introduction duct outside the heat treatment chamber, a heating device and a circulation fan for the hot air. The interior of the heat treatment chamber comprises a fiber travel path in which the fiber bundles each having a sheet shape horizontally travels the hot air flowing in a low-temperature region is directed to the high-temperature region side by an air direction change plate to be narrowed and flow in the width direction of the hot air introduction duct As a result, the temperature distribution in the width direction in the treatment chamber can be improved.

### TECHNICAL FIELD

The present invention relates to a method for producing a carbon fiber bundle and a heating furnace of a carbon fiber precursor fiber bundle, and it particularly relates to a method for producing a carbon fiber bundle using a heating furnace of a fiber bundle that can be suitably applied to a flameproofing furnace of a precursor fiber bundle in a carbon fiber bundle production process.

### BACKGROUND ART

The application fields of carbon fiber have been expanded more and more since it is excellent in specific strength, specific modulus, fire resistance, heat resistance, and durability. A carbon fiber is produced by firing a precursor fiber, and a process thereof includes a flameproofing process, a preliminary carbonization process, and a carbonization process. In the flameproofing process, the heat treatment of precursor fiber is performed in an oxidizing atmosphere so that the thermal stability is imparted to the precursor fiber. This flameproofing process is a process that requires the longest time in the carbon fiber production process, and is largely responsible for the exertion of the carbon fiber performance. Currently, in the carbon fiber manufacturing plant in operation, unevenness in treatment is caused to the carbon fiber since there is unevenness in temperature in the width direction in the flameproofing furnace.

In the flameproofing furnace in which a heat treatment chamber to heat-treat the running carbon fiber precursor fiber bundle with hot wind is adjacent to a circulating flow path to circulate the hot wind from the downstream portion of the heat treatment chamber to the upstream portion thereof, the temperature of the hot wind on side of the wall in contact with the outside air is low and the temperature on the wall side where the heat treatment chamber is in contact with the circulating flow path is high, and the hot wind is supplied to the heat treatment chamber while maintaining the temperature distribution even after passing through a blower fan, which causes the unevenness in temperature. The temperature distribution in the flameproofing furnace is required to be uniform from the viewpoint of uniform quality of carbon fiber and the improvement in yield.

A great number of specific proposals for eliminating the unevenness in temperature by the uniform temperature distribution in the flameproofing furnace have been made, for example, by JP 2000-088464 A (Patent Document 1) or JP 2001-288623 A (Patent Document 2), JP 2003-155629 A (Patent Document 3), JP 2008-138325 A (Patent Document 4), and JP 2008-280640 A (Patent Document 5). In addition to these, proposals for the uniform wind velocity and temperature distribution in the flameproofing furnace have been made, for example, by JP 2007-247130 A (Patent Document 6) and JP 2008-267794 A (Patent Document 7).

Furthermore, proposals for the uniform gas concentration treated by the hot wind circulation system have been made by JP 59-116419 A (Patent Document 8).

Specifically, in Patent Document 1, a hot wind blowing nozzle covered with a heat insulating material is provided in the vicinity of the fiber introduction and withdrawal portion in the heat treatment chamber so as to prevent heat loss and a heating means or a temperature control sensor is provided in the nozzle at the same time so as to compensate the lost heat. In Patent Document 2, a static mixer of a hot wind stirring device is provided in the convection heating type hot wind circulating flow path at the outside of the heat treatment chamber so as to have a pressure loss of 3 Pa or more when passing through this static mixer and to achieve the uniform distribution of particularly temperature and gas concentration in the heat treatment chamber of the hot wind circulating flow path, thereby eliminating the unevenness in treatment in the flameproofing process, and as a result, uniform physical properties of the continuous fiber bundle thus obtained are achieved and the production efficiency is improved at the same time.

In addition, according to Patent Document 3, the uniformity of the temperature in the treatment chamber and an increase in the production efficiency are achieved by providing a fin for wind direction change which protrudes from the inner wall of a double structure toward the yarn running direction as well as the unevenness in temperature in the treatment chamber due to heat loss through the furnace wall is prevented by adopting the double structure to the furnace wall of the flameproofing furnace. In Patent Document 4, the temperature variation in the furnace is suppressed within 10° C. by controlling the temperature of outside air in the vicinity of the entrance of the precursor fiber bundle of the flameproofing furnace.

According to Patent Document 5, both the side walls which are the outside of the heat treatment chamber and in the width direction of the heat treatment chamber are provided with the first and second hot wind circulating flow paths equipped with a hot wind blowing means, and one end of the first hot wind circulating flow path is connected to a first hot wind suction nozzle and one of the second wind circulating flow path is connected to a second hot wind suction nozzle as well as the other end of the first circulating flow path is connected to the first hot wind supply nozzle and the other end of the second hot wind circulating flow path is connected to the second hot wind supply nozzle so that both sides facing the yarn transport direction of the heat treatment chamber are surrounded by the first and second circulating flow paths, thereby preventing the heat loss to the outside of the heat treatment chamber, and also the hot wind circulating flow paths are arranged in multiple stages up and down on both sides in the width direction of the yarn and the hot wind is blown alternately up and down for each stage, thereby achieving the uniform distribution of temperature and wind velocity of hot wind in the yarn width direction.

According to Patent Document 6, two pieces of perforated plates are superimposed on the hot wind blowing port and the opening area is managed to be changeable by the parallel movement of one of the perforated plates, thereby providing a wind velocity control means in the width direction, and the uniform temperature of the yarn running in the heat treatment chamber is achieved by the flameproofing furnace having a wind direction changing plate installed in the yarn direction on both side wall surfaces in the width direction of the heat treatment chamber.

According to Patent Document 7, the inside of the folding roll is divided into a plurality of regions and at least one region is equipped with a controllable temperature adjusting means such as a heating means or a cooling means so as to control the temperature difference between fibers in the width direction, which leads to a decrease in the unevenness in heat treatment.

According to Patent Document 8, the gas flow divided into two divisions is allowed to pass through the fluid mixer immediately after having been merged together so as to be uniformly mixed and then circulated into the furnace, thereby eliminating the unevenness in quality between the yarns.

Patent Documents 2, 3, 4, 6, and 7 are proposed in order to achieve the uniform temperature distribution in the heat treatment chamber of the flameproofing furnace as the main purpose similarly to Patent Documents 1 and 5, but in all of them, the hot wind passes through to be perpendicular to the surface of yarn sheet transported in multiple stages up and down and thus the yarns are entangled together by the hot wind or a damage such as yarn breakage and fluffing is easily caused. With regard that point, in the heat treatment furnace of Patent Documents 1, 5 and 8, the hot wind flows to be parallel to the running direction of the fiber sheet running in the heat treatment, and thus the fiber sheet can be stably treated.

### CITATION LIST

### Patent Document

Patent Document 1: JP 2000-088464 A

Patent Document 2: JP 2001-288623 A

Patent Document 3: JP 2003-155629 A

Patent Document 4: JP 2008-138325 A

Patent Document 5: JP 2008-280640 A

Patent Document 6: JP 2007-247130 A

Patent Document 7: JP 2008-267794 A

Patent Document 8: JP 59-116419 A

### SUMMARY OF THE INVENTION

### Problem to be Solved by the Invention

However, in all of the flameproofing furnaces proposed by Patent Documents 1 to 8 described above, the flow path of the hot wind flowing in the furnace is a circulating flow path including the heat treatment chamber, and the heating device and the circulation fan are arranged in the middle of the circulating flow path excluding the heat treatment chamber. Among these, in Patent Document 2, a static mixer as a hot wind stirring device is disposed in the circulating flow path between the heating device and the circulation fan. Although the static mixer promotes the mixing by twisting the flow path in the horizontal and vertical direction, the extent of twisting of the flow path is merely enough to replace the adjacent regions sectioned by the mixing plate but is not enough to exhibit the function to mix the hot wind of the entire flow path, and thus the uniformity is achieved by a little heat transfer but is not sufficient. Similarly, in Patent Document 8, a stationary collision blade is installed as a fluid mixer, but this also changes only the position of flow in right and left and up and down and the function to mix the entire fluid is little. Hence, stirring of the hot wind in the inner region near the heat treatment chamber in the path width direction of the circulating flow path and the outer region near the wall in contact with the outside air are not performed and the hot wind flows for each course while almost not being mixed between the respective regions as well. In addition, the pressure loss is great and thus the load of power of the circulation fan increases.

This tendency is also observed in a case in which a stirring device is not arranged but only a circulation fan is arranged, moreover it has been demonstrated that the temperature of hot wind flowing in the outer region is relatively lower than the temperature of hot wind flowing in the inner region on the side wall surface of one side in contact with the outside air of the flow path inner wall, namely, the outer region and the side wall surface on the opposite side, namely, the inner region, and it has been demonstrated that there is the same tendency also in the temperature distribution of the hot wind introduced into the heat treatment chamber at the same time. Here, in the furnace body having the circulating flow path arranged next to the heat treatment chamber, the wall surface side where the circulating flow path is in contact with the heat treatment chamber is defined as the inner region and the wall surface side where the circulating flow path is in contact with the outside air is defined as the outer region.

In B of FIG. 15, the temperature distribution of the related art in the inflow cross section of the hot wind introduction portion 14 (see FIG. 1) when the upstream side is viewed from the hot wind downstream side of the hot wind introduction portion is illustrated in the thickness of color illustrated in A of FIG. 15. In this inflow cross section, R1 on the left side is the inner region and L1 on the right side is the outer region. FIG. 15 illustrates the state of the transition of temperature from a higher temperature to a lower temperature as the color shifts from the dark color portion to the light color portion. As can be seen from A and B in FIG. 15, the higher temperature region and the lower temperature region have a distribution state of being divided into two of the right side and the left side of the inflow cross section of the hot wind introduction portion. In other words, in the inflow cross section of the hot wind introduction portion 14, the higher temperature region spreads from the left side to the right side along the upper end edge and the lower end edge and the lower temperature region spreads from the right side to the center of left side. This temperature distribution shows the same tendency as the temperature distribution in the heat treatment chamber, and this temperature distribution is related to the unevenness in treatment in the width direction of the fiber sheet running in multiple stages up and down.

An object of the invention is to provide a heating furnace of a fiber bundle which is capable of achieving the uniform temperature distribution in the heat treatment chamber having such a temperature distribution form as well as realizing the reduction of the cost required for this, the heating furnace being equipped with a heat treatment chamber of a fiber bundle, particularly a heat treatment chamber suitable for the flameproofing process of a precursor fiber in the carbon fiber production process.

### Means for Solving Problem

The method for producing a carbon fiber of the invention is a method for producing a carbon fiber having a process of heating a substance to be heated with hot wind in an oxidative atmosphere at from 200 to 300° C. in a heating furnace having a heat treatment chamber and a hot wind introduction duct, in which hot wind is introduced into a hot wind mixing member by changing a part of the flow of hot wind flowing through the hot wind introduction duct by a wind direction changing member and increasing a maximum wind velocity between the wind direction changing member and the hot wind mixing member by 20% or more with respect to a cross-sectional average wind velocity of hot wind in the hot wind introduction duct and at the upstream site of the wind direction changing member and then introduced into the heat treatment when the hot wind is introduced from the hot wind introduction duct into the heat treatment chamber.

In the invention, it is preferable that the wind direction changing member be a plate material arranged on a flow path wall surface of the hot wind introduction duct, but the wind direction changing member is not limited thereto and may be a small-sized blower or a hot wind supply duct instead of the wind direction changing plate.

In the method for producing a carbon fiber of the invention, it is preferable that a hot wind introduction port of the hot wind mixing member be disposed to be perpendicular to a flow path direction of the hot wind introduction duct, and a distance Lx from the most downstream point of the wind direction changing member to a midpoint of an inlet width of the hot wind introduction port of the hot wind mixing member satisfies the following Equation (1).

Lx<(1.7 ln Re−2)×h (1)

Re=h×u/v

Here, h denotes the length in the flow path width direction of the wind direction changing member, u denotes the cross-sectional average wind velocity at the upstream site of the wind direction changing member, v denotes the kinematic viscosity of hot wind and ln denotes natural logarithm.

In addition, in the method for producing a carbon fiber of the invention, it is preferable that a distance Lx from the most downstream point of the wind direction changing member to a midpoint of an inlet width of the hot wind introduction port of the mixing member, which is parallel to a flow path direction of the hot wind introduction duct and a distance Ly from the most downstream point of the wind direction changing member to the most upstream point of the hot wind introduction port of the mixing member, which is perpendicular to a flow path direction of the hot wind introduction duct satisfy the following Equations (1) and (2).

Lx<(1.7 ln Re−2)×h (1)

Ly<6h (2)

In the method for producing a carbon fiber of the invention, it is preferable that the hot wind mixing member be a small-sized blower, a static mixer, or a stirrer.

It is preferable that an area obtained by projecting the wind direction changing plate on a flow path cross section of the hot wind introduction duct perpendicular to a hot wind traveling direction be 10% or more and 60% or less with respect to an area of the flow path cross section of the hot wind introduction duct when the wind direction changing member is a wind direction changing plate arranged on the flow path wall surface of the hot wind introduction duct.

Moreover, it is preferable that the angle of the wind direction changing plate with respect to the hot wind flow be adjustable.

In the method for producing a carbon fiber of the invention, it is preferable that a temperature difference of hot wind to be jetted into the heat treatment chamber through a hot wind introduction port on a surface of the hot wind introduction port be within 10° C.

The heating furnace of the invention is a heating furnace having a heat treatment chamber to heat a carbon fiber precursor and a hot wind introduction duct to introduce hot wind in an oxidative atmosphere at from 200 to 300° C. into the heat treatment chamber, and a wind direction changing member to change a part of the flow of hot wind flowing through the hot wind introduction duct and a hot wind mixing member when the hot wind is introduced from the hot wind introduction duct into the heat treatment chamber via a circulation fan.

It is preferable that the wind direction changing member be a plate material arranged on a flow path wall surface of the introduction duct, a small-sized blower, or a hot wind supply duct. In addition, it is desirable that a hot wind mixing member be arranged at the downstream site of the wind direction changing member, and with regard to the hot wind mixing member, it is preferable that a distance Lx from the most downstream point of the wind direction changing member to a midpoint of an inlet width of a hot wind introduction port of the hot wind mixing member satisfy the following Equation (1) in a case in which a surface of a hot wind introduction port of the hot wind mixing member is disposed to be perpendicular to a flow path direction of a hot wind introduction duct.

Lx<(1.7 ln Re−2)×h (1)

Re=h×u/v

Here, h denotes the length in the flow path width direction of the wind direction changing member, u denotes the cross-sectional average wind velocity at the upstream site of the wind direction changing member, v denotes the kinematic viscosity of hot wind and ln denotes natural logarithm.

It is desirable that a distance Lx from the most downstream point of the wind direction changing member to a midpoint of an inlet width of a hot wind introduction port of the hot wind mixing member, which is parallel to a flow path direction of the hot wind duct and a distance Ly from the most downstream point of the wind direction changing member to the most upstream point of a hot wind introduction port of a hot wind mixing member different from the a hot wind mixing member, which is perpendicular to a flow path direction of the hot wind duct satisfy the following Equations (1) and (2) in a case in which a surface of a hot wind introduction port of the hot wind mixing member is not disposed to be perpendicular to a flow path direction of a hot wind introduction duct.

Lx<(1.7 ln Re−2)×h (1)

Ly<6h (2)

It is desirable that the hot wind mixing member be a small-sized blower, a static mixer, or a stirrer. It is desirable that a static mixer or a stirrer be disposed between the wind direction changing member and the circulation fan in the case of using a static mixer or a stirrer as the hot wind mixing member.

The function of the static mixer in this case is to bring the hot wind in the higher temperature region closer to the hot wind in the lower temperature region so as to cause the heat transfer, thereby facilitating the temperature uniformity of hot wind as well as to switch the flow path.

It is preferable that an area obtained by projecting the wind direction changing member on a flow path cross section of a hot wind introduction duct perpendicular to a hot wind traveling direction be 10% or more and 60% or less with respect to an area of the flow path cross section of the hot wind introduction duct when the wind direction changing member is a wind direction changing plate arranged on the flow path wall surface of the introduction duct.

### Effect of the Invention

According to the invention equipped with the above configuration, the following unique effects are exhibited.

(1) Uniformity of Temperature Distribution

The uniform temperature distribution in the fiber sheet width direction in the heat treatment chamber can be achieved and the heat treatment with respect to the fiber sheet is also equalized, and thus a homogeneous and high-quality product is obtained. Here, the fiber sheet refers to a state in which a plurality of fiber bundles are aligned in parallel, and the fiber sheet width direction refers to a direction in which the fiber bundles are aligned. In addition, the cross-sectional area in the circulating flow path by the wind direction changing plate is about 10% of the total flow path cross-sectional area, and thus the pressure loss is small and a decrease in wind velocity is hardly caused.

(2) Advantage in Cost

The fabrication, attachment, and detachment are easy in a case in which the wind direction changing plate has a simple structure such as a mere plate material, and thus the raw material cost, production cost, and construction cost for installation are significantly low. Here, it is advantageous in terms of cost for the hot wind mixing member as well in a case in which the hot wind mixing member is configured by the same member as the wind direction changing plate.

### BRIEF DESCRIPTION OF DRAWINGS

FIG. 1 is a plan view illustrating an internal structure example of the fiber sheet heat treatment furnace of the invention;

FIG. 2 is a plan view illustrating the schematically enlarged inside of the installation portion of the wind direction changing plate according to the invention;

FIG. 3 is an arrow view along the line III-III in FIG. 2;

FIG. 4 is an installation example of the wind direction changing member (wind direction changing plate) and the hot wind mixing member (circulation fan);

FIG. 5 is an installation example of the wind direction changing member (wind direction changing plate), the hot wind mixing member, and the circulation fan;

FIG. 6 is an installation example of the wind direction changing member (wind direction changing plate) and the hot wind mixing member (circulation fan);

FIG. 7 is an installation example of the wind direction changing member (wind direction changing plate) and the hot wind mixing member (circulation fan);

FIG. 8 is an installation example of the wind direction changing member (blower) and the hot wind mixing member (circulation fan);

FIG. 9 is an installation example of the wind direction changing member (blower) and the hot wind mixing member (circulation fan);

FIG. 10 is an installation example of the wind direction changing member (hot wind supply duct) and the hot wind mixing member (circulation fan);

FIG. 11 is a graph illustrating the data for temperature distribution in the width direction in the sheet-shaped fiber bundle running path of the first stage from the upper end for the comparison of a case in which the wind direction changing plate is installed with a case in which the wind direction changing plate is not installed;

FIG. 12 is a graph illustrating the data for temperature distribution in the width direction in the sheet-shaped fiber bundle running path of the second stage from the upper end for the comparison of the two cases;

FIG. 13 is a graph illustrating the data for temperature distribution in the width direction in the sheet-shaped fiber bundle running path of the third stage from the upper end for the comparison of the two cases;

FIG. 14 is a graph illustrating the data for temperature distribution in the width direction in the sheet-shaped fiber bundle running path of the fourth stage from the upper end for the comparison of the two cases; and

FIG. 15 is a vertical and horizontal temperature distribution diagram at a hot wind inlet of the hot wind introduction portion when the wind direction changing plate is not installed.

### MODE(S) FOR CARRYING OUT THE INVENTION

Hereinafter, representative embodiments of the invention will be more specifically described with reference to the accompanying drawings.

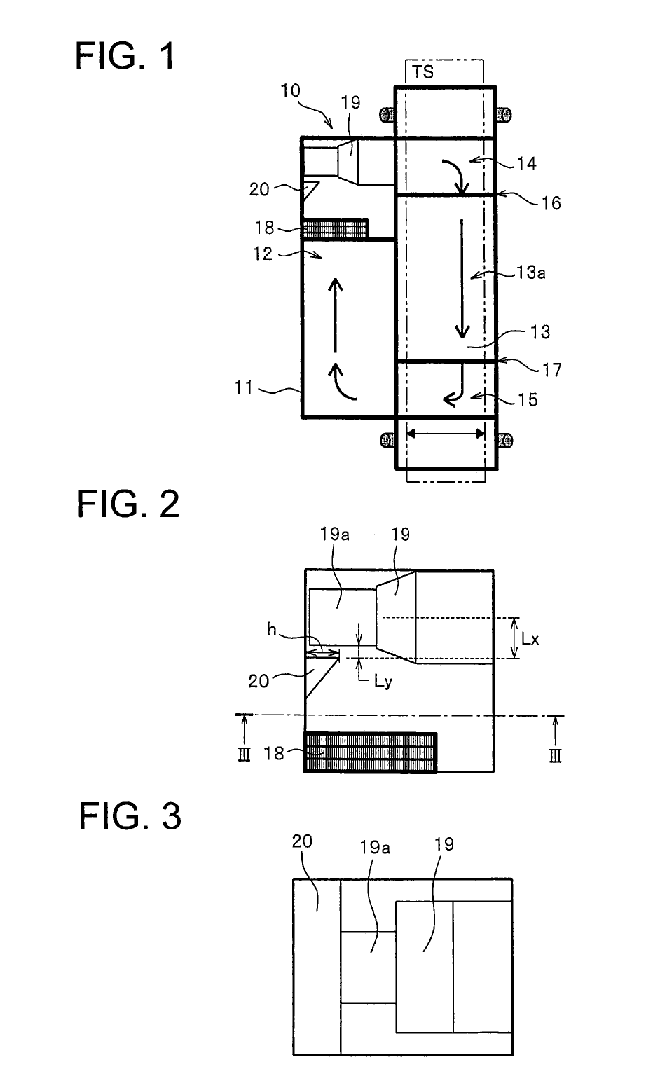

FIG. 1 is a schematic plan view of a part of the inside of the hot wind heat circulating path in the heating furnace of the invention viewed from the upper, FIG. 2 is a plan view illustrating the schematically enlarged inside of the installation portion of the wind direction changing plate with respect to the hot wind mixing member (circulation fan) according to the invention, and FIG. 3 is an arrow view along the line III-III in FIG. 2. The flameproofing furnace arranged in the flameproofing process of the production process of a carbon fiber is exemplified as the heating furnace according to the present embodiment, but the heating furnace is not necessarily limited to the flameproofing furnace. In addition, in this embodiment, a circulating type parallel flow heat treatment furnace is used in which hot wind flows parallel to the running direction of the sheet-shaped continuous fiber bundle (hereinafter, refers to the fiber sheet) running in one direction in the heat treatment chamber arranged in a part of the hot wind circulating flow path.

The hot wind circulating flow path of a heating furnace 10 according to the present embodiment is equipped with a furnace wall 11 having a rectangular frame shape in planar view and a hot wind introduction duct 12 is formed to utilize the internal horizontal space thereof as illustrated in FIG. 1. A heat treatment chamber 13 to heat-treat a continuous fiber sheet TS is arranged to be adjacent to this hot wind introduction duct 12. Here, in the heating furnace 10, one hot wind introduction duct 12, one circulation fan 19, and one hot wind blowing port 16 are arranged for one heat treatment chamber 13, and hot wind circulates through the hot wind introduction duct 12 and the heat treatment chamber 13. In addition, the heating furnace has a single racing structure in which the circulating direction of hot wind is only one direction. There is a sheet treatment space 13a in which the continuous fiber sheet TS runs in multiple stages up and down in the heat treatment chamber 13. Here, the continuous fiber sheet TS is exemplified as an object to be heat-treated in the present embodiment, but the present embodiment includes treating a plurality of continuous fiber bundles aligned in parallel.

In order to allow the continuous fiber sheet TS to run in multiple stages up and down, a plurality of folding rollers (not illustrated) extending in the sheet width direction are arranged in the outdoor up and down direction of both end portions in the fiber sheet running direction of the heat treatment chamber 13 in multiple stages, and the continuous fiber sheet TS introduced from the fiber sheet supply port formed at one end of the heat treatment chamber 13 runs the inside of the heat treatment chamber 13 to be folded by the folding rollers (not illustrated) arranged at the fiber sheet outlet of the first stage, runs through the inside of the heat treatment chamber 13 in the reverse direction to be folded by the folding rollers of the second stage arranged at the fiber sheet outlet formed at the other end of the heat treatment chamber 13, and runs through the inside of the heat treatment chamber 13 in the reverse direction. The continuous fiber sheet TS is sent out through the final outlet for the next process when this is repeated as many as the required number of stages and thus the predetermined heat treatment is performed.

The heat treatment described above is continuously performed by introducing a gas that is prepared by raising the temperature of the hot wind flowing through the hot wind introduction duct 12 to a predetermined temperature into the heat treatment chamber 13. According to the present embodiment, heated air is used as the gas, and the atmosphere temperature in the heat treatment chamber 13 is set to approximately from 200 to 300° C. In addition, an acrylonitrile-based long fiber which is a representative precursor fiber of carbon fiber is used as the raw material fiber of the continuous fiber sheet TS used in the present embodiment.

A hot wind introduction portion 14 and a hot wind withdrawal portion 15 which are arranged along the hot wind introduction duct 12 to be adjacent to the sheet entrance of the heat treatment chamber 13 are additionally installed to the heat treatment chamber 13, in addition to the entrance of the continuous fiber sheet TS and the plurality of folding rollers arranged at the same entrance of the continuous fiber sheet TS. The connection portions between the hot wind introduction portion 14 and the heat treatment chamber 13, and the hot wind withdrawal portion 15 and the heat treatment chamber 13 are provided with a hot wind blowing port 16 to blow fresh hot wind into the heat treatment chamber 13 and a hot wind suction port 17 to suck the hot wind from the heat treatment chamber 13 into the hot wind introduction duct 12, respectively. Each of the hot wind introduction portion 14 and the hot wind withdrawal portion 15 is aligned in parallel in two or more stages in the perpendicular direction, and a fiber sheet supply port (not illustrated) is arranged therebetween, and the fiber sheet passes therethrough.

A heating device 18 and a circulation fan 19 are sequentially installed to the hot wind introduction duct 12 excluding the heat treatment chamber and on the circulating flow path between the upstream side of the hot wind introduction portion 14 and the downstream side of the hot wind withdrawal portion 15 toward the downstream side from the upstream side of the hot wind direction. In other words, the hot wind having a decreased temperature after the heat treatment of the continuous fiber sheet TS in the heat treatment chamber 13 is sucked out into the hot wind withdrawal portion 15 via the hot wind suction port 17, and a part thereof is replaced with fresh air by the hot wind introduction duct 12 in the middle, and the hot wind is subjected to the heat exchange and then heated to the required temperature by passing through the heating device 18. At this time, with regard to the temperature of the hot wind in the flow path width direction flowing through the circulating flow path, the temperature of the hot wind in the outer region is lower than that of the hot wind in the inner region. In the related art, the temperature distribution at this time is the same as the distribution illustrated in B of FIG. 15, and this distribution is not changed when the hot wind flows through the inside of the heat treatment chamber 13. The hot wind heated by the heating device 18 is supplied into the hot wind introduction portion 14 by the circulation fan 19 which rotates around a circulation fan shaft 19a.

Incidentally, according to this embodiment, the circulation fan 19 disposed on the circulating flow path is installed at a corner portion of the heating furnace 10 to be parallel to the inflow port of the hot wind introduction portion 14, and its type is an axial flow type. The rotational speed thereof is 1800 rpm, and the hot wind turns the flow path at right angles, flows into the circulation fan 19, passes through the rotor blade at a flow rate of 10 m³/min and gyrates to pass through the stator blade as well, and then flows into the hot wind introduction portion 14. Here, the hot wind passing through the outer region is cooled by heat loss through the wall surface in contact with outside air, and thus the temperature thereof is lower than that of the hot wind passing through the inner region. Structures such as an exhaust port or a supply port of hot wind, a wire mesh portion, and a heating unit are arranged in the circulating flow path, and the hot wind is swiveled by the circulation fan 19 and supplied into the heat treatment chamber after passing through these structures. At the time of passing through a series of flow paths, the treated gas of lower temperature hot wind in the outer region and the treated gas of higher temperature hot wind in the inner region are never mixed but are circulated while maintaining the temperature distribution in the width direction. By virtue of this, the temperature of hot wind positioned on the outer wall side in the width direction of the sheet is relatively lower than the temperature of hot wind in the center of the furnace body in the heat treatment chamber 13. This is the unevenness in temperature in the sheet width direction and causes the nonuniformity of the reaction.

The invention is intended to prevent such temperature distribution tendency in the heat treatment chamber 13.

According to the invention, as already described, it is possible to promote the mixing and heat transfer between the hot wind in the lower temperature region and the hot wind in the higher temperature region by introducing the hot wind into the hot wind mixing member in a state in which a part of the flow of hot wind is changed, the flow velocity of hot wind is increased, and the hot wind having a lower temperature is close to the hot wind having a higher temperature. As the hot wind mixing member, it is possible to use the circulation fan as the hot wind mixing member as well or it is also possible to use a separate static mixer or stirrer. In addition, the flow of hot wind having a lower temperature which passes along the wall surface exhibiting great heat loss is simultaneously sucked into the inflow portion of the circulation fan 19 into which the higher temperature region flows in the related art by arranging a wind direction changing plate 20 which leads at least the hot wind in the lower temperature region to the higher temperature region, and thus it is possible to promote the mixing of hot wind in the lower temperature region and higher temperature region by the circulation fan 19. This wind direction changing plate 20 can be installed in close proximity to only the region where a temperature decrease is concerned, and thus it is possible to achieve the fine uniform temperature distribution corresponding to the unique temperature distribution in the heat treatment chamber. For this reason, in the illustrated embodiment, the wind direction changing plate 20 which changes the flow of hot wind flowing along the side wall surface of the outer circulating flow path facing the heat treatment chamber 13 to the side wall side adjacent to the heat treatment chamber 13 is arranged on this side wall surface over the entire height in the height direction of the hot wind circulating flow path between the heating device 18 and the mixing member (circulation fan 19) as illustrated in FIG. 1 to FIG. 3.

The means to increase the flow velocity of the hot wind by changing a part of the hot wind flow is not limited to the wind direction changing plate and may be a means to narrow the flow path itself or it is also possible to use another wind direction changing member such as a small-sized blower 21 or a hot wind supply duct 22 which is different from the circulation fan 19.

Here, the hot wind supply duct 22 is another duct which is different from the hot wind introduction duct 12, and this hot wind supply duct is a duct to introduce and supply hot wind to the downstream side in the same manner as the hot wind introduction duct 12. The hot wind flowing through the hot wind supply duct may be the hot wind temporarily separated from the hot wind introduction duct 12 or hot wind to be newly introduced. The small-sized blower 21 is installed in the flow path such that a velocity and an angle can be imparted to a part of the fluid in the hot wind introduction duct so as to be oblique to the main flow.

The hot win supply duct is preferably provided with a fan and a heater.

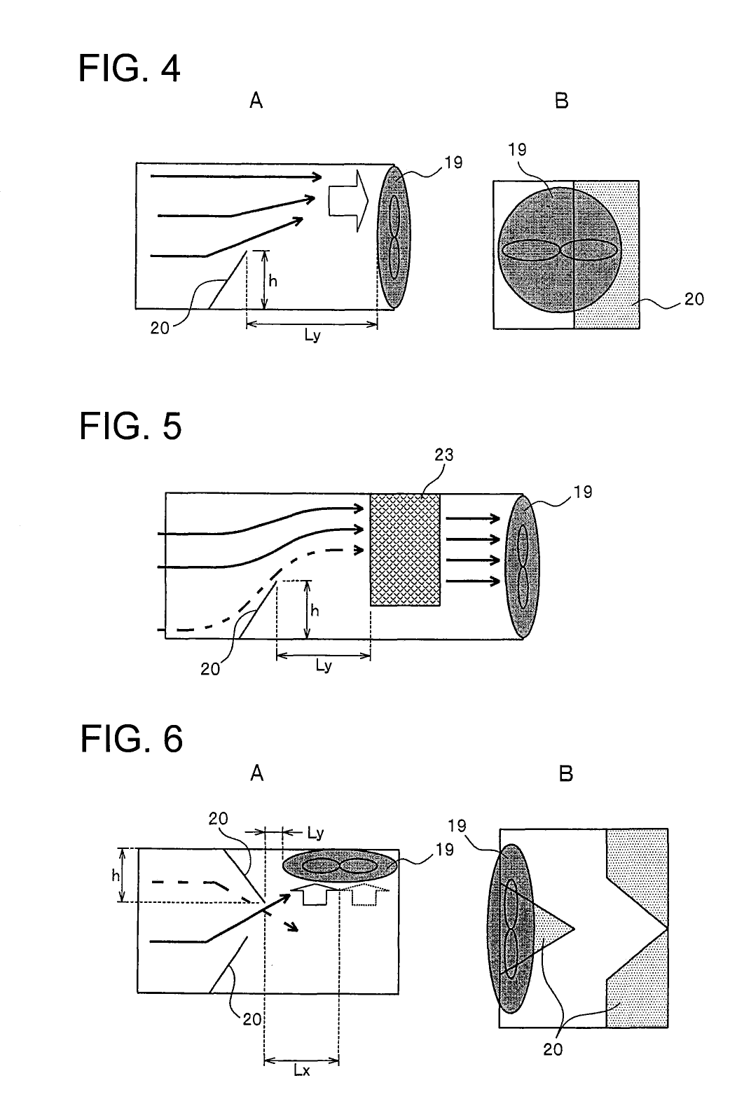

FIG. 4 to FIG. 10 illustrate a modification example of the wind direction changing member including the wind direction changing plate 20, the small-sized blower 21 and the hot wind supply duct 22 to change the flow of the hot wind illustrated in FIG. 1, and an installation example of the hot wind mixing member including the circulation fan 19 and a static mixer. A is a flow path plan view and B is a cross-sectional projection view viewed from the upstream side of the flow path. The arrows indicate the flow of hot wind. FIGS. 4 to 7 adopt the wind direction changing plate 20 as wind direction changing member, FIGS. 8 and 9 adopt the small-sized blower 21 as the wind direction changing member, and FIG. 10 adopts the hot wind supply duct 22 as the wind direction changing member and the circulation fan 19 and a static mixer as the hot wind mixing member. In the plan view A, the fluid flowing on the upper side of the flow path has a higher temperature and the fluid flowing on the lower side has a lower temperature.

According to the embodiment of FIG. 1 described above, a triangular prism-shaped SUS plate material directing the slope at 45° in the traveling direction of the hot wind is adopted as the wind direction changing plate 20, and the size thereof is set to 200 mm to cover about 40% of 480 mm which is the dimension from the wall on the side in contact with the outside air to the hot wind inflow surface of the circulation fan 19.

The wind direction changing plate 20 illustrated in A and B of FIG. 4 is configured by a plate material for changing the flow of hot wind flowing along the heat treatment chamber 13 side toward the hot wind flowing along the wall surface on the side opposite to the heat treatment chamber 13 to be inclined by 45° in the traveling direction of the hot wind. The flow of hot wind in the vicinity of the wall surface on the lower temperature side come straight from the upstream site hits the wind direction changing plate 20 to be suppressed, reaches the inflow surface of the hot wind mixing member (circulation fan 19) before adhering to the wall surface on the lower temperature side again, flows into the hot wind mixing member (circulation fan 19) through the same surface as the flow flowing on the higher temperature side, is mixed when passing through the hot wind mixing member (circulation fan 19) and then supplied to the treatment chamber.

In the embodiment illustrated in FIG. 5, an example is illustrated in which the hot wind mixing member is disposed behind the wind direction changing plate 20 and the circulation fan is disposed therebehind.

Here, examples of the hot wind mixing member include a static mixer or a stirrer.

The heat exchange is easily conducted between the hot wind in the higher temperature region and the hot wind in the lower temperature region in a case in which the hot wind in the higher temperature region and the hot wind in the lower temperature region are introduced into a static mixer in a state of being close to each other as described above, and thus the temperature of hot wind is likely to be uniform.

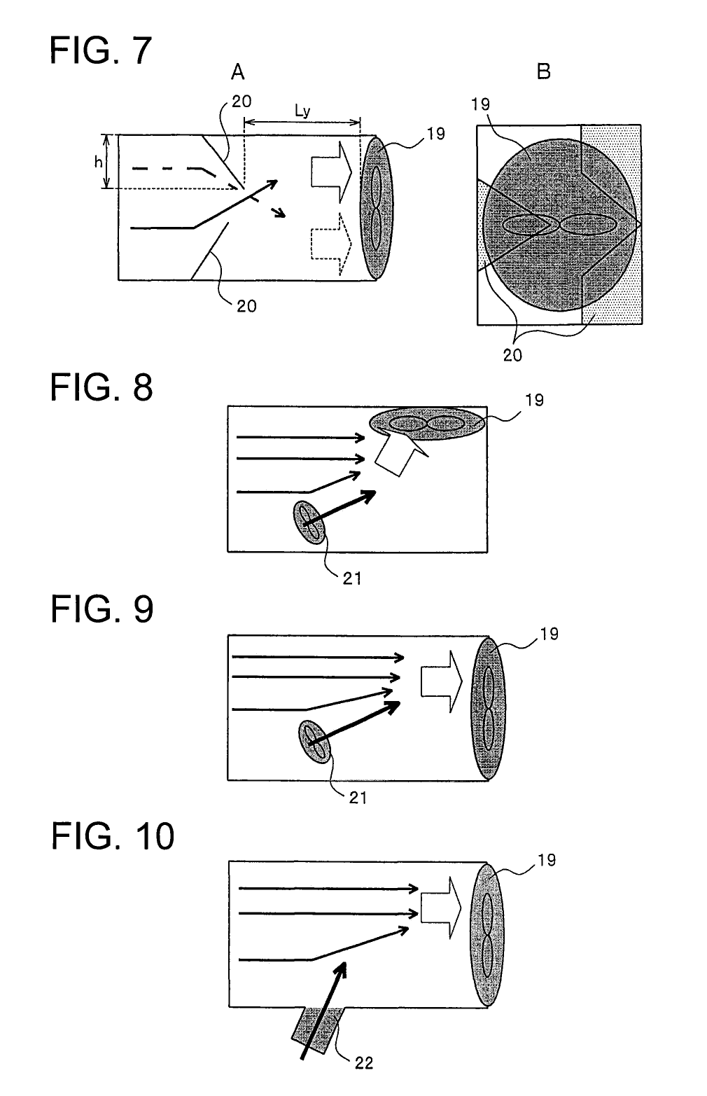

In the embodiments illustrated in A and B of FIG. 6 and A and B of FIG. 7, examples of a case in which the circulation fan 19 that also functions as the hot wind mixing member is disposed to be orthogonal to the traveling direction of the hot wind and a case in which the circulation fan 19 is disposed to be parallel to the traveling direction of the hot wind, and the wall surface on the heat treatment chamber side facing the width direction of the hot wind introduction duct 12 and the wall surface on the outer wall side are provided with a pair of wind direction changing plates 20 inclined at an angle of 45° and the wind direction changing plate 20 having an equilateral triangle cross section toward the hot wind introduction surface of the circulation fan 19. Hence, by disposing the wind direction changing plate 20 in this manner, the flow on the higher temperature side indicated by the dotted line and the flow on the lower temperature side indicated by the solid line hit the wind direction changing plate 20 arranged on each wall surface to be suppressed and flow to the downstream, but by alternately arranging the height of the wind direction changing plate 20 on both side surfaces, it is possible to move a part of the flow on the lower temperature side flowing to be parallel from the upstream side of the hot wind introduction duct 12 to the higher temperature side and a part of the flow on the higher temperature side to the lower temperature side. The hot wind is allowed to flow into the circulation fan 19 in a state in which the unevenness in temperature distribution on the higher temperature side and the lower temperature side is alleviated in advance so as to promote the mixing of hot wind at the time of passing through the circulation fan, thereby achieving the uniform temperature distribution between the hot winds when there is a great temperature difference between the higher temperature side and the lower temperature side.

FIGS. 8 and 9 are examples in which a small-sized blower 21 is arranged as the wind direction changing member, and the disposition angles of the circulation fan 19 for hot wind supply with respect to respective flow paths are different from each other. The small-sized blower 21 is arranged obliquely to the flow direction of the flow path of the hot wind introduction duct 12 at a part in the hot wind introduction duct 12. The flow rate and the flow velocity are adjusted by disposing the small-sized blower 21 in this manner so as to impart an angle and the inertial force to the hot wind, and the hot wind is allowed to flow into the circulation fan 19 through the same surface as the main flow flowing to be parallel from the upstream side of to the hot wind introduction duct 12, and thus the hot winds are mixed at the time of passing through the circulation fan 19, thereby achieving the uniform temperature distribution between the hot winds passing through the heat treatment chamber 13.

A plurality of the small-sized blowers 21 may be disposed in the height direction.

A mere hot wind supply duct 22 is used as the wind direction changing member illustrated in FIG. 10, hot wind having a temperature raised to the required temperature at the outside is supplied to this hot wind supply duct 22 with the required pressure, and the hot wind supply duct 22 changes the flow of the hot wind on the higher temperature side and the hot wind on the lower temperature side flowing to be parallel from the upstream side of the hot wind introduction duct 12 toward the hot wind introduction surface of the circulation fan 19 and sufficiently mixes them at the same time, thereby achieving the uniform temperature distribution between the hot winds passing through the heat treatment chamber 13. The temperature of the hot wind sent through the hot wind supply duct 22 at this time can be freely adjusted from the outside, and it is possible to arbitrarily adjust the temperature of hot wind to be introduced into the heat treatment chamber 13 by adjusting that temperature.

The angle between the wind direction changing plate 20 and the wall surface from the wind direction changing plate 20 to the hot wind circulating flow path on the hot wind downstream side is preferably 20° or more and 90° or less. The hot wind on the side wall surface is easily directed to the facing side wall surface when the angle is 20° or more, and the retention of hot wind is easily prevented when the angle is 90° or less. The angle is more preferably 30° or more and 60° or less from these points of view. With regard to the direction of the small-sized blower 21 and the hot wind supply duct 22 which are the wind direction changing members 21 and 22 as well, it is desirable to dispose them to have the same slope as the wind direction changing plate 20 described above.

It is preferable that the angle of the wind direction changing members 20, 21, and 22 can be adjusted. By virtue of this, it is also possible to manage a case in which the temperature of the heat treatment chamber 13 and the flow rate of hot wind are changed by the kind of the substance to be heated, by one member.

With regard to the size of the wind direction changing plate 20, the area of the wind direction changing plate 20 projected on the cross section of the hot wind circulating flow path perpendicular to the hot wind traveling direction is preferably 10% or more and 60% or less with respect to the cross-sectional area of the hot wind circulating flow path. The hot wind on the side wall surface is easily directed to the facing side wall surface when the area is 10% or more, and the area is more preferably 25% or more. The pressure loss does not increase and thus the load of the circulation fan 19 is likely to decrease when the area is 60% or less.

With regard to the positional relationship between the wind direction changing member and the hot wind mixing member, it is preferable that the distance Lx from the most downstream point of the wind direction changing member to the midpoint of the inlet width of the hot wind introduction port of the hot wind mixing member, which is parallel to the hot wind introduction duct satisfies the following Equation (1) in a case in which the surface of the hot wind introduction port of the hot wind mixing member is disposed to be perpendicular to the hot wind flow path direction of the hot wind introduction duct.

Lx<(1.7 ln Re−2)×h (1)

Here, Re=h×u/v

h: length in flow path width direction of wind direction changing member

u: cross-sectional average wind velocity at upstream site of wind direction changing member

v: kinematic viscosity of hot wind and

ln: natural logarithm.

It is possible to introduce hot wind into the blower fan in a state in which the hot wind having a higher temperature is close to the hot wind having a lower temperature and the hot wind having a higher temperature is mixed with the hot wind having a lower temperature by the blower fan, and thus it is possible to reduce the unevenness in temperature when the Lx is in the range to satisfy Equation (1) above.

It is preferable that the distance Lx from the most downstream point of the wind direction changing member to the midpoint of the inlet width of the hot wind introduction port of the mixing member, which is parallel to the hot wind introduction duct and the distance Ly from the most downstream point of the wind direction changing member to the most upstream point of the hot wind introduction port of the mixing member, which is perpendicular to the hot wind introduction duct satisfy the following Equations (1) and (2) in a case in which the surface of the hot wind introduction port of the hot wind mixing member is not perpendicular to the hot wind flow path direction of the hot wind introduction duct.

Lx<(1.7 ln Re−2)−h (1)

Ly<6h (2)

It is possible to introduce hot wind into the circulation fan 19 in a state in which the hot wind having a higher temperature is close to the hot wind having a lower temperature and the hot wind having a higher temperature is mixed with the hot wind having a lower temperature by the circulation fan 19, and thus it is possible to reduce the unevenness in temperature when the Lx and the Ly are in the range to satisfy Equations (1) and (2) above.

With regard to the wind direction changing plate 20, it is even more preferable that the tip of the triangular prism face the inside of the circulation fan inflow port. Here, values of these are not limited, and the height, disposition width, or disposed position thereof is also not limited to the illustrated examples and can be arbitrarily changed as necessary. The shape of the wind direction changing plate 20 can also be a flat plate or a curved surface protruding the surface facing hot wind up and down other than the triangular prism.

Moreover, in the present embodiment, it is also possible to dispose a second heater in front of the hot wind inlet of the hot wind introduction portion 14 in order to achieve more uniform temperature distribution in the sheet width direction of the hot wind to be introduced into the heat treatment chamber 13.

The hot wind mixing member is preferably a circulation fan, a static mixer or a stirrer, and a circulation fan or a stirrer which performs active mixing is preferable among them, and a circulation fan that is also equipped with the mechanism to blow hot wind is efficient and thus more preferable. Moreover, the circulation fan is an essential member for supplying hot wind into the heat treatment chamber, and thus the hot wind mixing member is arranged between the wind direction changing member and the circulation fan in the case of using a static mixer or a stirrer as the hot wind mixing member. Here, a static mixer is installed at the upstream site of the circulation fan in Patent Document 2, but the invention has an advantage in terms that the flow on the higher temperature side and the flow on the lower temperature side are allowed to flow into the same surface of the static mixer in advance by arranging the wind direction changing member at the further upstream site of the static mixer and thus the mixing effect can be promoted.

In addition, it is more favorable as the distance from the hot wind withdrawal port of the hot wind mixing member to the hot wind introduction port connected to the heat treatment chamber is shorter in order to suppress the occurrence of unevenness in temperature there. It is possible to reduce the occurrence of unevenness in temperature when the distance from the hot wind withdrawal port of the hot wind mixing member to the hot wind introduction port connected to the heat treatment chamber is shorter than the treated substance running longitudinal direction of the heat treatment chamber, but the distance is preferably four times or less the width of the hot wind introduction port connected to the heat treatment chamber and more preferably 2 times or less.

Furthermore, it is preferable that the temperature difference in the width direction on the surface of the hot wind introduction port to introduce hot wind into the heat treatment chamber be within 10° C. It is possible to reduce the unevenness in heating of each fiber bundle when the temperature difference is within 10° C., and thus it is possible to obtain a uniform fiber bundle. The temperature difference is more preferably 7° C. or lower and even more preferably 3° C. or lower from that point of view.

Hereinafter, the invention will be more specifically described based on Examples and Comparative Examples.

### EXAMPLES

### Example 1

For a case in which the wind direction changing plate is installed to the heating furnace equipped with the configuration illustrated in FIG. 1 to FIG. 3 and a case in which the wind direction changing plate is not installed thereto, the path width direction temperature at the longitudinal direction central portion of each running path in the heat treatment chamber were measured at five points for each path using 4 paths formed between the upper and lower folding rollers (not illustrated) without passing the fiber sheet through the fiber sheet running paths (path) from the first stage to the fourth stage from the top, and the temperature distribution in the path width direction and height direction was examined. The average temperature in the heat treatment furnace at this time was 240° C. Incidentally, the wind direction changing plate is arranged in contact with the entire side wall surface facing the heat treatment chamber on the upstream side of the circulation fan as the wind direction changing member, and the size thereof has a depth in the hot wind flow direction of 200 mm and an equilateral triangle cross section having a surface inclined by 45° with a dimension in the path width direction of 200 mm. Here, the hot wind mixing member is a circulation fan, and the wind velocity when passing through the hot wind introduction duct at the upstream site of the wind direction changing plate is 8 m/s on the average. The hot wind introduction port of the circulation fan is disposed in the hot wind introduction duct to be parallel to the flow path direction, the distance Lx from the most downstream point of the wind direction changing plate to the midpoint of the inlet width of the hot wind introduction port of the circulation fan, which is parallel to the flow path direction of the hot wind introduction duct is 540 mm, and the distance Ly from the most downstream point of the wind direction changing plate to the most upstream point of the hot wind introduction port of the circulation fan, which is perpendicular to the flow path direction of the hot wind introduction duct is 280 mm.

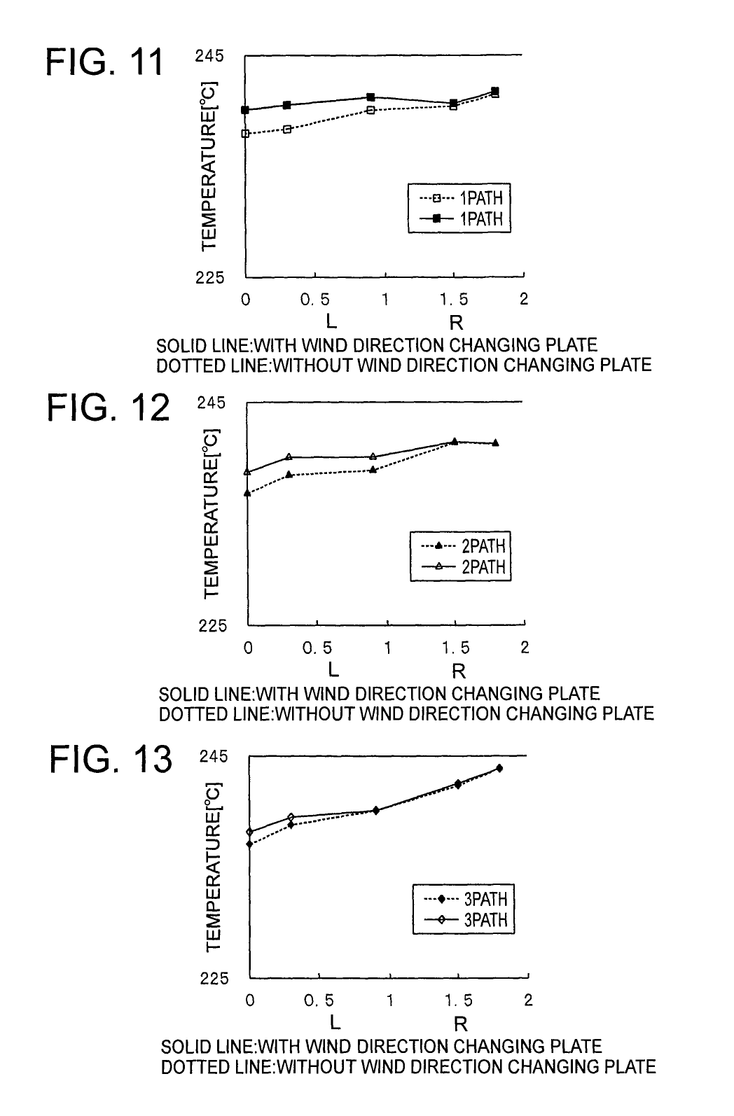

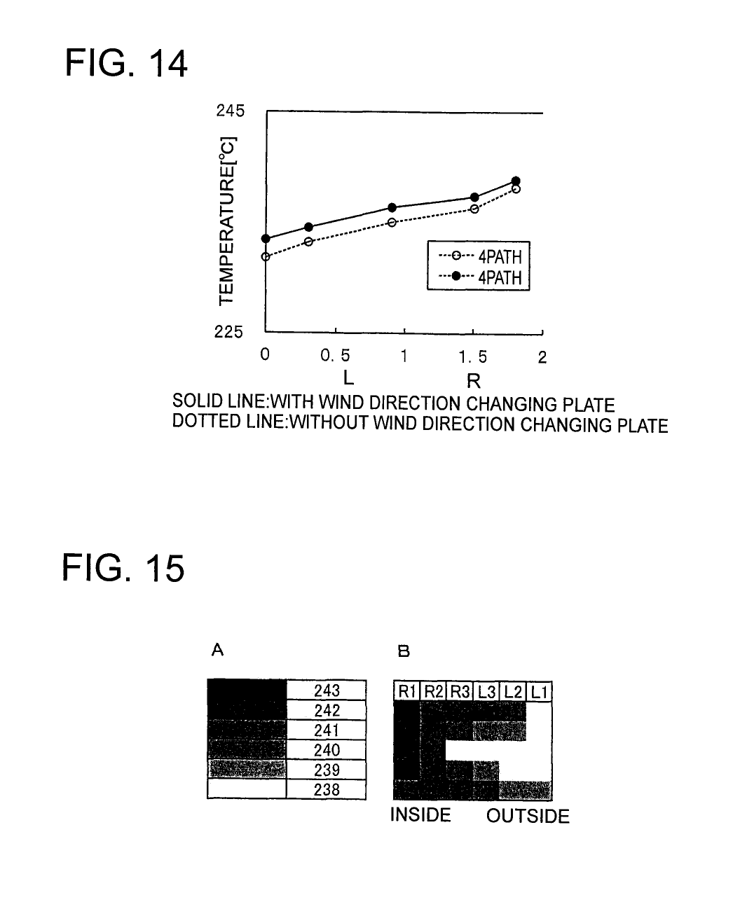

The temperature at the positions of 5 points equally arranged in the width direction of each path in the longitudinal direction central portion of the heat treatment chamber was measured while the hot wind was circulating in the heat treatment furnace using each of the temperature sensors installed in the furnace, and the temperature of each measurement point was recorded. The results are illustrated in FIG. 11 to FIG. 14, and the temperature difference between both ends, namely the value obtained by subtracting the temperature on the outer circle side from the temperature on the inner circle side is summarized in Table 1. In FIG. 11 to FIG. 14, the solid line indicates the case in which a wind direction changing plate is installed and the dotted line indicates the case in which a wind direction changing plate is not installed, and the sign L indicates the flow on the wall side in contact with the outside air in the sheet width direction, namely of the outer circle and R indicates the flow on the wall side in contact with the circulating flow path in the seat width direction, namely of the inner circle. As presented in Table 1, the outer circle of hot wind has a relatively lower temperature than the inner circle between the outer circle and the inner circle of hot wind before and after the installation of the wind direction changing plate in the paths of the first stage to the fourth stage, and the temperature difference between the inner circle and the outer circle in each path was 1.74° C., 2.70° C., 6.25° C., and 6.26° C. from the top when the wind direction changing plate was installed, thus it can be understood that the temperature difference after the installation of the wind direction changing plate is reduced in all the paths.

### Comparative Example 1

The temperature at the positions of 5 points equally arranged in the width direction of each path was measured in the same manner as in Example 1 without installing the wind direction changing plate on the upstream side of the circulation fan which is installed in the circulating flow path in the heat treatment furnace configured by the paths having the first stage to the fourth stage and without allowing the fiber sheet to pass through the treatment space of the heat treatment chamber, and the temperature difference in the width direction of each path in the furnace at 240° C. on the average was 3.66° C., 4.72° C., 7.59° C., and 7.35° C. from the top as presented in Table 1. As can be understood from the results, the temperature distribution in the heat treatment chamber of the related art is as follows. The temperature of the inner circle is significantly higher than the temperature of the outer circle in the width direction of the circulating flow path, and the temperature difference therebetween is great.

TABLE 1
Temperature difference between both ends in sheet width direction

| LR difference | 1 path | 2 path | 3 path | 4 path |
|---|---|---|---|---|
| Example 1 | 1.74 | 2.70 | 6.25 | 6.26 |
| Comparative Example 1 | 3.66 | 4.72 | 7.59 | 7.35 |
| Improvement width | 1.92 | 2.02 | 1.34 | 1.10 |

### Example 2

The experiment was conducted under the same conditions as in Example 1 except that an acrylonitrile-based precursor fiber sheet passed through the circulating flow path in the heat treatment furnace configured by the paths having the first stage to the fourth stage. The results are presented in Table 2. The temperature difference in the width direction of each path in the furnace at 240° C. on the average was 1.98° C., 2.84° C., 6.63° C., and 7.88° C. from the top as presented in Table 2.

### Comparative Example 2

A PAN-based precursor was introduced into the furnace while the hot wind was circulated in a state in which nothing is installed on the circulation fan upstream side of the circulating flow path in the heat treatment furnace configured by the paths having the first stage to the fourth stage, and the temperature of 5 points in the width direction of each path was measured in the treatment chamber longitudinal direction center. The temperature difference in the width direction of each path in the furnace at 240° C. on the average was 3.87° C., 5.02° C., 8.08° C., and 9.43° C. from the top. From this result, it can be understood that the temperature distribution in the heat treatment chamber of the related art is as follows. The temperature of the inner circle is relatively higher than the temperature of the outer circle in the width direction of the circulating flow path in a case in which a fiber sheet passes through, and the temperature difference therebetween is also significantly great compared with a case in which a fiber sheet does not pass through.

TABLE 2
Temperature difference between both ends in sheet width direction

| LR difference | 1 path | 2 path | 3 path | 4 path |
|---|---|---|---|---|
| Example 2 | 1.98 | 2.84 | 6.63 | 7.88 |
| Comparative Example 2 | 3.87 | 5.02 | 8.08 | 9.43 |
| Improvement width | 1.89 | 2.19 | 1.45 | 1.56 |

In the above Examples and Comparative Examples, the temperature measurement was performed by the temperature sensor installed at the fixed position in the furnace as already described above and the values thus obtained were compared with one another, but the same results were obtained even when the thermocouple was installed in the width direction of each position of the closest position from the hot wind blowing port in the furnace and the closest position from the hot wind suction port thereof, and the data obtained by the temperature detector were compared with one another.

### Example 3

Wind direction changing plates were installed alternately in the height direction on both side surfaces as illustrated in FIG. 6 at the upstream site of the circulation fan in the flow path in which hot wind was flowing in the hot wind introduction duct having the flow path cross section of 1 m² at an average wind velocity of 8 m/s. The average temperature in the hot wind introduction duct at this time was 236° C. Here, the circulation fan that is the hot wind mixing member is disposed to be perpendicular to the flow path direction of the hot wind introduction duct, the distance Lx from the most downstream point of the wind direction changing plate to the most upstream point of the circulation fan, which is in the parallel direction to the hot wind introduction duct is 500 mm. The length in the flow path width direction of the plate on one side is 500 mm and the length on the other side is 400 mm, and the area of all the wind direction changing plates projected on the flow path cross section of the hot wind introduction duct perpendicular to the hot wind traveling direction is 57% with respect to the area of the flow path cross section of the hot wind introduction duct. Here, the temperature of 5 points in the height direction and 5 points in the width direction in the above cross section at the downstream position by 500 mm from the circulation fan was measured, and the temperature difference between both ends obtained by subtracting the temperature in the hot wind introduction duct of the end portion on the L side on the hot wind introduction duct outer side from the temperature in the hot wind introduction duct of the end portion on the R side on the hot wind introduction duct inner side in each height was 3.5° C., 6.2° C., 4.6° C., and −0.2° C. from the upper stage as presented in Table 3. It can be understood that the temperature difference after the installation of the wind direction changing plate is reduced compared with Comparative Example 3 in which the wind direction changing plate is not installed.

### Example 4

A duct to supply heated air from the outside as illustrated in FIG. 10 was connected to the flow path wall surface of the outer circle at the upstream site by 1000 mm from the most upstream point of the circulation fan in the flow path in which hot wind was flowing in the hot wind introduction duct having the flow path cross section of 1 m² at an average wind velocity of 8 m/s. Here, the wind direction changing member is a hot wind supply duct, and this duct is arranged to be connected at an angle of 45° with respect to the hot wind introduction duct of the main flow and supplies the hot wind at 250° C. The average temperature in the hot wind introduction duct at this time was 236° C. The temperature of 5 points in the height direction and 5 points in the width direction in the cross section at the downstream by 500 mm from the circulation fan was measured, and the temperature difference between both ends obtained by subtracting the temperature in the hot wind introduction duct of the end portion on the L side on the hot wind introduction duct outer side from the temperature in the hot wind introduction duct of the end portion on the R side on the hot wind introduction duct inner side in each height was 3.4° C., 6.3° C., 5.0° C., and −1.4° C. from the upper stage as presented in Table 3. Here, the high and low of temperature on the L side and the R side was reversed in the lower stage, and thus it was possible to eliminate the tendency that the outer circle was a lower temperature region.

### Comparative Example 3

Nothing was installed at the upstream site of the circulation fan in the flow path in which hot wind was flowing in the hot wind introduction duct having the flow path cross section of 1 m² at an average wind velocity of 8 m/s, the temperature of 5 points in the height direction and 5 points in the width direction in the cross section at the downstream by 500 mm from the circulation fan was measured, and the temperature difference between both ends in each height was 3.6° C., 7.6° C., 9.6° C., and 5.6° C. from the upper stage. As presented in Table 3, the temperature difference in the width direction was greater compared with Example 3 and 4 in which the same duct was installed as the wind direction changing member, and thus it is expected that this tendency remains even in the heat treatment chamber at the downstream.

TABLE 3

| | Temperature difference between | | | | Improvement width of | | | |
|---|---|---|---|---|---|---|---|---|
| | both ends in sheet width | | | | temperature difference between | | | |
| | direction ( [symbol] C.) | | | | both ends of LR ( [symbol] C.) | | | |
| | 1 path | 2 path | 3 path | 4 path | 1 path | 2 path | 3 path | 4 path |
| Example 3 | 3.5 | 6.2 | 4.6 | −0.2 | 0.1 | 1.3 | 5.0 | 4.8 |
| Example 4 | 3.4 | 6.3 | 5.0 | −1.4 | 0.2 | 1.3 | 4.5 | 3.6 |
| Comparative | 3.6 | 7.6 | 9.6 | 5.0 | — | — | — | — |
| Example 3 | | | | | | | | |

As described above, with regard to the hot wind in the lower temperature region flowing along the wall surface in contact with the outside air, the flow of wind along the wall surface was suppressed by the wind direction changing member disposed on the wall surface before flowing into the hot wind mixing member so as to control the wind direction to the higher temperature region and the hot wind in the higher temperature region and the hot wind in the lower temperature region were allowed to flow into the same surface of the hot wind mixing member and mixed together, and as a result, it was possible to improve the temperature distribution in the width direction in the treatment chamber. On the other hand, the wind velocity in the width direction in the heat treatment chamber was measured under the conditions of Example 1 and Comparative Example 1, but any change in the wind velocity distribution of the treatment chamber due to the presence or absence of wind direction changing plate was not observed.

### EXPLANATIONS OF LETTERS OR NUMERALS

10 heating furnace
11 furnace wall
12 hot wind introduction duct
13 heat treatment chamber
13a sheet treatment space
14 hot wind introduction portion
15 hot wind withdrawal portion
16 hot wind blowing port
17 hot wind suction port
18 heating device
19 circulation fan
19a circulation fan shaft
20 wind direction changing member (wind direction changing plate)
21 wind direction changing member (small-sized blower)
22 wind direction changing member (hot wind supply duct)
23 hot wind mixing member
TS continuous fiber sheet

1. A method for producing a carbon fiber comprising:
a process of heating a substance to be heated with hot wind in an oxidative atmosphere at from 200 to 300° C. in a heating furnace having a heat treatment chamber and a hot wind introduction duct, wherein
when the hot wind is introduced from the hot wind introduction duct into the heat treatment chamber via a circulation fan, the hot wind is introduced into a hot wind mixing member by changing a part of the flow of hot wind flowing through the hot wind introduction duct by a wind direction changing member, and increasing a maximum wind velocity between the wind direction changing member and the hot wind mixing member by 20% or more with respect to a cross-sectional average wind velocity of hot wind in the hot wind introduction duct and at the upstream site of the wind direction changing member, and then the hot wind is introduced into the heat treatment chamber.

2. The method for producing a carbon fiber according to claim 1, wherein the wind direction changing member is a plate material arranged on a flow path wall surface of a hot wind introduction duct.

3. The method for producing a carbon fiber according to claim 1, wherein the wind direction changing member is a small-sized blower or a hot wind supply duct.

4. The method for producing a carbon fiber according to claim 2, wherein a hot wind introduction port of the hot wind mixing member is disposed to be perpendicular to a flow path direction of a hot wind introduction duct, and a distance Lx from the most downstream point of the wind direction changing member to a midpoint of an inlet width of the hot wind introduction port of the hot wind mixing member, which is parallel to the hot wind introduction duct satisfies the following Equation (1).
Lx<(1.7 ln Re−2)×h (1)
Re=h×u/v
h: length in flow path width direction of wind direction changing member
u: cross-sectional average wind velocity at upstream site of wind direction changing member
v: kinematic viscosity of hot wind
ln: natural logarithm

5. The method for producing a carbon fiber according to claim 2, wherein a distance Lx from the most downstream point of the wind direction changing member to a midpoint of an inlet width of the hot wind introduction port of the hot wind mixing member, which is parallel to the hot wind introduction duct and a distance Ly from the most downstream point of the wind direction changing member to the most upstream point of the hot wind introduction port of the hot wind mixing member, which is perpendicular to the hot wind introduction duct satisfy the following Equations (1) and (2).
Lx<(1.7 ln Re−2)×h (1)
Ly<6h (2)

6. The method for producing a carbon fiber according to any one of claims 1 to 5, wherein the hot wind mixing member is a small-sized blower, a static mixer, or a stirrer.

7. The method for producing a carbon fiber according to claim 2, wherein an area of the wind direction changing member projected on a flow path cross section of the hot wind introduction duct perpendicular to a hot wind traveling direction is 10% or more and 60% or less with respect to an area of the flow path cross section of the hot wind introduction duct at the most upstream point of the wind direction changing member.

8. The method for producing a carbon fiber according to any one of claims 1 to 7, wherein a temperature difference on a surface of the hot win introduction port to introduce hot wind into a heat treatment chamber is within 10° C.

9. A heating furnace comprising:
a heat treatment chamber to heat a carbon fiber precursor fiber bundle with hot wind and
a hot wind introduction duct to introduce hot wind in an oxidative atmosphere at from 200 to 300° C. into the heat treatment chamber,
wherein the heating furnace includes a wind direction changing member to change a part of the flow of hot wind flowing through the hot wind introduction duct and
a hot wind mixing member having a function to mix the flow passing through when the hot wind is introduced from the hot wind introduction duct into the heat treatment chamber via a circulation fan.

10. The heating furnace according to claim 9, wherein the wind direction changing member is a plate material arranged on a flow path wall surface of the hot wind introduction duct, a small-sized blower, or a hot wind supply duct.

11. The heating furnace according to claim 10, wherein a hot wind mixing member is arranged at the downstream site of the wind direction changing member, the hot wind mixing member is disposed to be perpendicular to a flow path direction of a hot wind introduction duct, and a distance Lx from the most downstream point of the wind direction changing member to a midpoint of an inlet width of a hot wind introduction port of the hot wind mixing member satisfies the following Equation (1).
Lx<(1.7 ln Re−2)×h (1)
Re=h×u/v
h: length in flow path width direction of wind direction changing member
u: cross-sectional average wind velocity at upstream site of wind direction changing member
v: kinematic viscosity of hot wind
ln: natural logarithm

12. The heating furnace according to claim 10, wherein a distance Lx from the most downstream point of the wind direction changing member to a midpoint of an inlet width of a hot wind introduction port of the hot wind mixing member and a distance Ly from the most downstream point of the wind direction changing member to the most upstream point of a hot wind introduction port of a hot wind mixing member different from the hot wind mixing member satisfy the following Equations (1) and (2).
Lx<(1.7 ln Re−2)×h (1)
Lx<6h (2)

13. The heating furnace according to any one of claims 9 to 12,
wherein the hot wind mixing member is a small-sized blower, a static mixer, or a stirrer.

14. The heating furnace according to claim 9, wherein an area of the wind direction changing member projected on a flow path cross section of a hot wind introduction duct perpendicular to a hot wind traveling direction is 10% or more and 60% or less with respect to an area of the flow path cross section of the hot wind introduction duct.

15. A method for producing a carbon fiber comprising:
a process of heating a substance to be heated with hot wind in an oxidative atmosphere at from 200 to 300° C. in a heating furnace having a heat treatment chamber and a hot wind introduction duct, wherein
when the hot wind is introduced from the hot wind introduction duct into the heat treatment chamber via a circulation fan, the hot wind is introduced into a hot wind mixing member by changing a part of the flow of hot wind flowing through the hot wind introduction duct by a wind direction changing member, the flow path of hot wind is narrowed, and then the hot wind is introduced into the heat treatment chamber.

16. The method for producing a carbon fiber according to claim 15, wherein the wind direction changing member is a plate material arranged on a flow path wall surface of a hot wind introduction duct.

17. The method for producing a carbon fiber according to claim 16, wherein the wind direction changing plate is arranged in contact with the entire side wall surface facing the heat treatment chamber on the upstream side of the circulation fan.

18. The method for producing a carbon fiber according to claim 16, wherein an area of the wind direction changing member projected on a flow path cross section of the hot wind introduction duct perpendicular to a hot wind traveling direction is 10% or more and 60% or less with respect to an area of the flow path cross section of the hot wind introduction duct.

19. The method for producing a carbon fiber according to claim 16, wherein a hot wind mixing member is arranged at the downstream site of the wind direction changing member, the hot wind mixing member is disposed to be perpendicular to a flow path direction of a hot wind introduction duct, and a distance Lx from the most downstream point of the wind direction changing member to a midpoint of an inlet width of a hot wind introduction port of the hot wind mixing member satisfies the following Equation (1).
Lx<(1.7 ln Re−2)×h (1)
Re=h×u/v
h: length in flow path width direction of wind direction changing member
u: cross-sectional average wind velocity at upstream site of wind direction changing member
v: kinematic viscosity of hot wind
ln: natural logarithm

20. The method for producing a carbon fiber according to claim 16, wherein a distance Lx from the most downstream point of the wind direction changing member to a midpoint of an inlet width of a hot wind introduction port of the hot wind mixing member and a distance Ly from the most downstream point of the wind direction changing member to the most upstream point of a hot wind introduction port of a hot wind mixing member different from the hot wind mixing member satisfy the following Equations (1) and (2).
Lx<(1.7 ln Re−2)×h (1)
Lx<6h (2)

21. The method for producing a carbon fiber according to any one of claims 15 to 20, wherein the hot wind mixing member is a circulation fan, a static mixer, or a stirrer.
